(19) United States
(12) Patent Application Publication
(10) Pub. No.: US 2005/0236249 A1
(43) Pub. Date: Oct. 27, 2005

(54) Transfer gearbox with controllable coupling device for a motor vehicle

(76) Inventors: Detlef Baasch, Friedrichshafen (DE); Christoph Pelchen, Tettnang (DE); Karl-Hermann Ketteler, Markdorf (DE); Ulrich Mair, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/110,177

(22) Filed: Apr. 20, 2005

(30) Foreign Application Priority Data
Apr. 21, 2004 (DE) 10 2004 019 216.2

(51) Int. Cl. F16D 19/00; F16D 27/00; F16D 37/02; F16D 21/00; F16D 23/00

(52) U.S. Cl. 192/84.6; 192/84.7; 192/94

(57) ABSTRACT

A transfer transmission (1) is described having a regulatable coupling device (5) for a motor vehicle, particularly for a motor vehicle having engageable all-wheel drive, for distributing an input torque introduced in a housing (28) via an input shaft (2) to at least two output shafts (3, 4). One output shaft (4) can be connected via the coupling device (5) with the input shaft (2) and the coupling device (5) can be actuated via one electric motor (7) and one input converter device (8) situated between the electric motor (7) and the coupling device (5) for converting a rotator motion of the electric motor (7) to a translatory actuating motion for the coupling device (5). One axle offset between the input shaft (2) and the output shaft (4) connectable there is bridged via one CVT unit (6). The electric motor (7) is integrated in the housing (28).

According to the type defined in detail in the preamble of claim 1, the invention concerns a transfer transmission with controllable coupling device.

From the practice are known lockage transfer transmissions for an all-wheel drive or motor vehicle drafts having engageable all-wheel drive in which a locking or coupling function for engaging one or more drive axles is performed, respectively, with one coupling device designed as a multi-disc clutch. The coupling device is preferably actuated by one electric motor which acts, for example, via a reduction step carried out as spur gear stage, upon a toothed segment ring which is, in turn, connected with one spindle of an input converter device.

When the coupling device is closed or dragging, part of the input torque of a prime mover introduced in the housing, via an input shaft of the transfer transmission, is transmitted to a first transmission output shaft directly connected with the transmission input shaft and the other part of the input torque is transmitted, via a CVT unit, to a second output shaft of the transfer transmission. The CVT unit is provided for bridging an axle offset between the transmission input shaft and the second transmission output shaft.

One spindle nut coordinated with the spindle or situated upon the spindle is rotatorily fixed in such a transfer transmission and upon a rotation motion of the spindle, corresponding to a pitch of a thread of the spindle, is adjusted in axial direction. According to a direction of rotation of the electric motor, the coupling device is closed or opened via the axial motion of the spindle nut.

The electric motor is located outside the housing of the transfer transmission and designed with its own housing. The coupling device is driven via one shaft which is passed through the housing of the transfer transmission into the interior of the transfer transmission and is finally operatively connected via the input converter device with a coupling device.

However, the electric motor is disadvantageously located outside the transfer transmission, giving to a transfer transmission, a shape unfavorable for integration in a drive train of a motor vehicle and, in addition, causing need for a larger installation space, based on the area wise, due to the electric motor projecting.

Therefore, the instant invention is based on the problem of providing a transfer transmission having an external shape easy to integrate in a drive train and characterized by requiring small installation space.

This problem is solved by the invention with a transfer transmission according to the features of claim 1.

The inventive transfer transmission does not require much installation space; can be easily integrated in the housing of the transfer transmission, and has no more projecting parts in the outside of the transmission housing whereby the transfer transmission can be designed with an external shape easy to integrate in a drive train.

Furthermore, by virtue of the inventive compact design of the transfer transmission, so-called package advantages are obtained in comparison with an external arrangement of the electric motor. The electric motor is also substantially better protected from environmental influences, such as pollution, air humidity and the like since, unlike in an external arrangement, it is, in addition, surrounded by the housing of the transfer transmission.

In an advantageous development of the transfer transmission, the electric motor is situated in the housing of the transfer transmission in an area defined by a pull strand and a return strand of the CVT unit so that the electric motor is placed in a hitherto practically unused area of the interior of the transfer transmission. Thereby the external measurements of the housing of the transfer transmission are only, if at all, negligibly larger compared to a transfer transmission known from the practice.

Other advantages and advantageous developments of the object of the invention result from the claims and the embodiments described basically with reference to the drawing, there being used in the description of the different embodiments for better clarity the same reference numerals for parts having the same structure and function. The drawing shows:

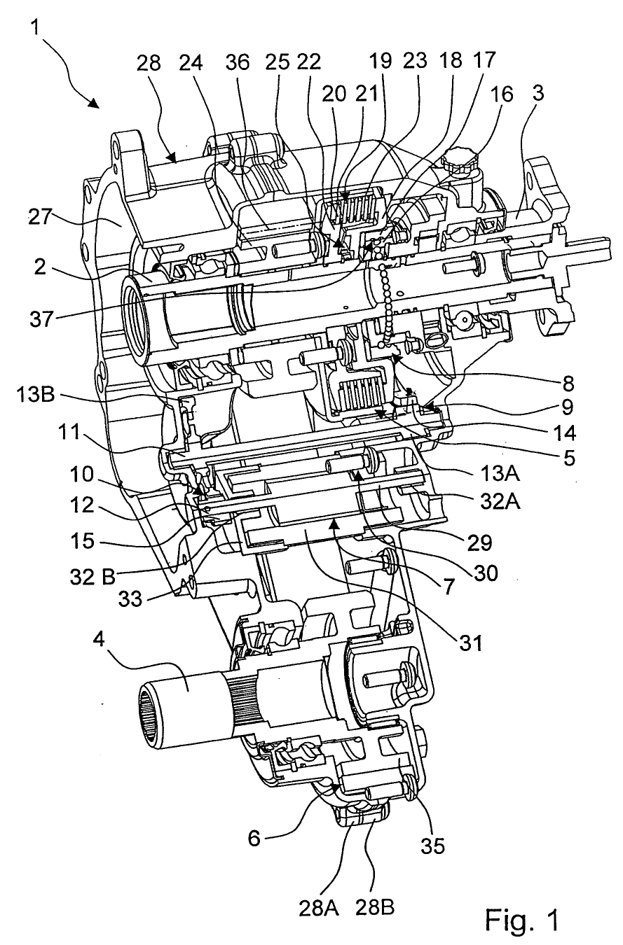

FIG. 1 is a three-dimensional partial section of an inventively designed transfer transmission;

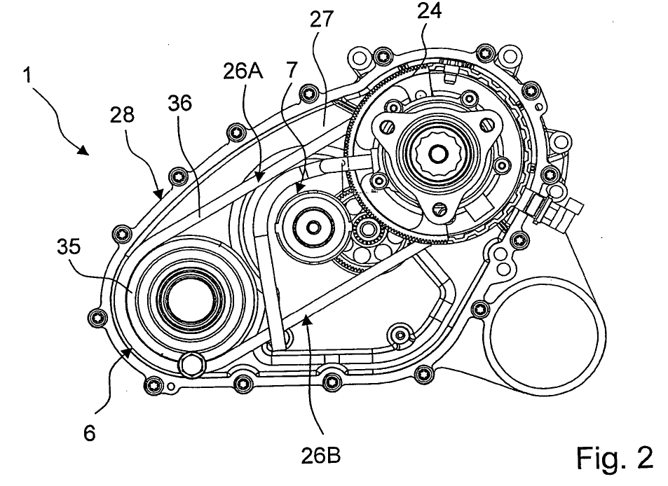

FIG. 2 is a side view of the transfer transmission shown in FIG. 1;

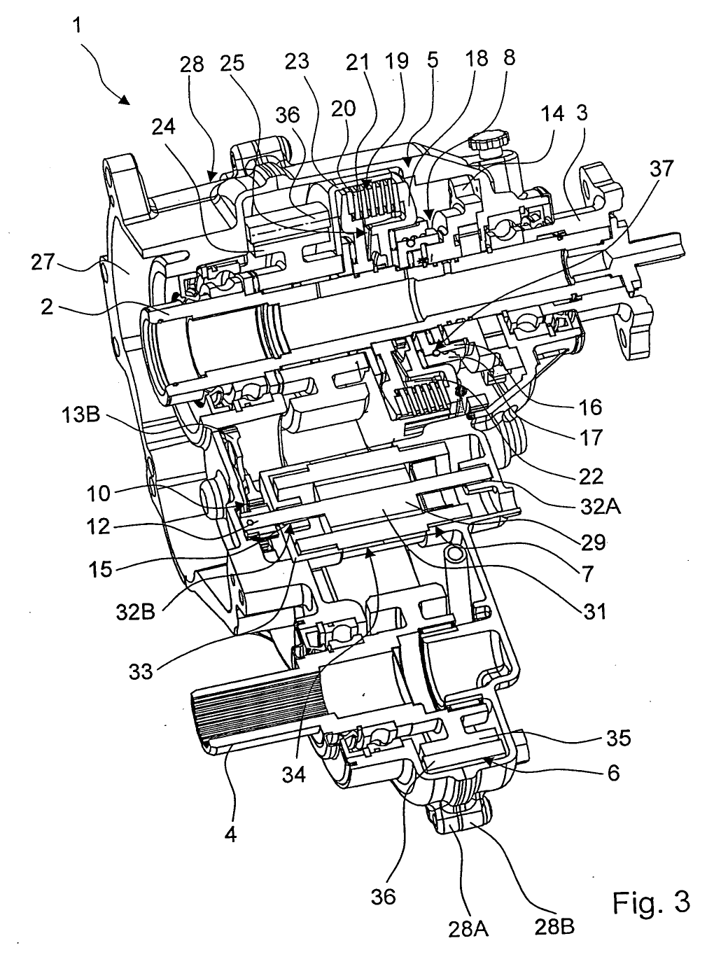

FIG. 3 is a three-dimensional partial section of another design of an inventively designed transfer transmission where the electric motor is encased in relation to an inner space of the transfer transmission;

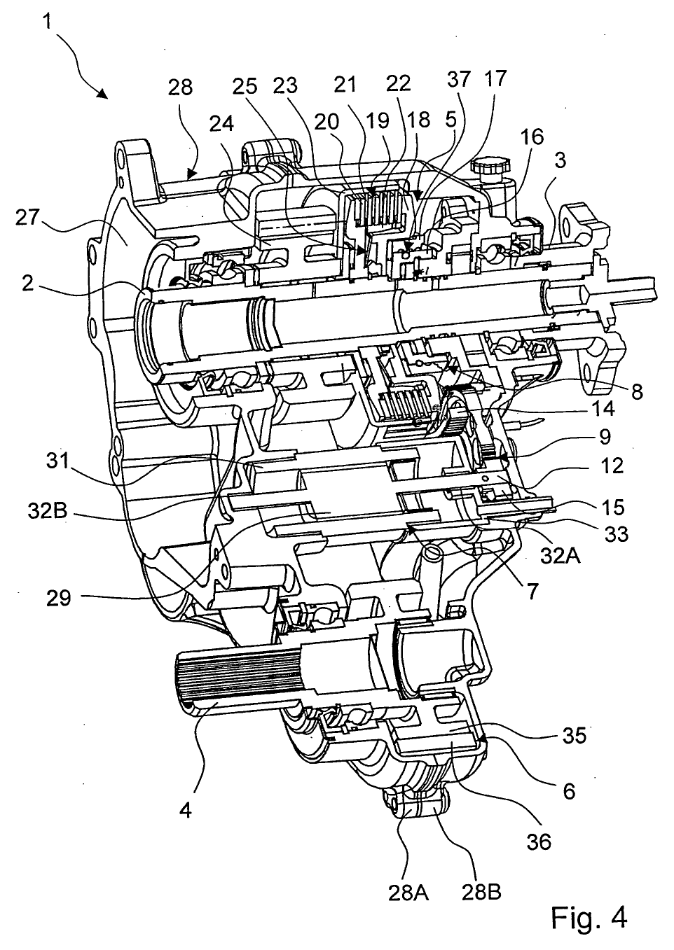

FIG. 4 is one other design of an inventive transfer transmission in three-dimensional partial section; and

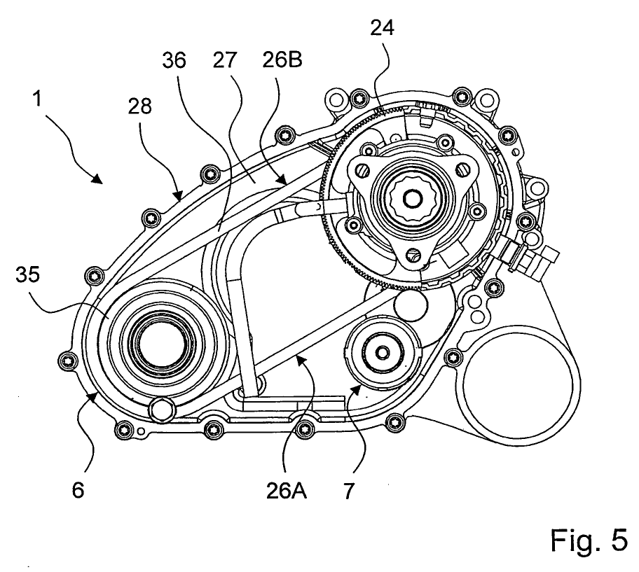

FIG. 5 is a side view of an inventively designed transfer transmission where the electric motor is located outside an area defined by a CVT unit.

In FIG. 1 is shown a transfer transmission 1 in a three-dimensional partial section view and is designed as a longitudinal transfer transmission by way of which a torque, introduced via an input shaft 2, can be passed to two output shaft 3, 4.

The first output shaft 3 is directly connected with the input shaft 2 so that the input torque is passed directly from the input shaft 2 to the first output shaft 3. The second output shaft 4 is connected via one regulatable coupling device 5 and one CVT unit 6 with the input shaft 2 when the coupling device 5 is in a state in which a torque can be passed via the coupling device 5.

The coupling device 5 can be actuated via one electric motor 7, one input converter device 8 is situated between the coupling device 5 and the electric motor 7 by way of which a rotatory motion of the electric motor 7 is transformed to a translatory motion for controlling the coupling device 5.

An input converter device 8 is here in operative connection via two spur gear stages 9, 10 and one countershaft 11 with a motor output shaft 12 of the electric motor 7. The first spur gear stage 9 is formed here by one spur gear 13A connected with the countershaft 11 and one toothed gear segment 14 of the input converter device 8. The second spur gear stage 10 comprises one other spur gear 13B connected with the countershaft 11 and meshing with a spur gear 15 connected with the output shaft 12 of the electric motor 7. Both spur gear stages 9 and 10 constitute two reduction steps between the electric motor 7 and the input converter device 8; the ratios of which are laid out so that an optimum can be made available between acceleration capacity, controlling force and controlling time.

Alternative to the spur gear stages 9 and 10, it can also be provided that the rotatory drive of the electric motor 7 be transmitted by the output shaft 12 to a spindle 16 of the input converter device 8 via one chain.

The toothed wheel segment 14 is connected with one spindle 16 of a spindle-spindle nut arrangement of the input converter device 8 so that a rotational motion of the toothed wheel segment 14 is directly transmitted to the spindle 16. The connection or the operative connection between the spindle 16 and the toothed wheel segment 14 is implemented via a riveting connection. It is obviously at the expert's discretion to produce a non-rotatable connection between the toothed wheel segment 14 and the spindle 16 alternatively to the riveting connection via any other suitable kind of connection such as screwing, pressing, soldering or the like.

Upon the spindle 16 is one spindle nut 17 movably supported in axial direction of the input shaft 2 and rotatorily fixed in the transfer transmission while the spindle 16 is rotatably supported upon the input shaft 2 and fixed in axial direction in the transfer transmission 1.

The spindle-spindle nut arrangement of the input converter device 8 and a pitch of a spindle thread, shaped here as a ball thread 37, are constructed so that during a closing operation of the coupling device 5, the spindle 16 has the same direction of rotation as the input shaft 2. Thereby drag torques, which appear as a result of frictional forces between the spindle 16 and the input shaft 2, favor the closing operation of the coupling device 5.

The drag torques, appearing during a closing operation of the coupling device 5, can be used as input for the spindle of the input converter device 8 as an alternative to the above described procedure. It can also be provided that the spindle 16 be designed counterclockwise or clockwise oriented so that the direction of rotation of the input shaft assists the opening operation of the coupling device 4 by the drag torques then suitably differently directed.

The spindle or the threaded spindle 16 has one or more closed threads designed with a pitch of more than 1 and functionally developed so that a defined degree of efficiency appears. With the aid of these steps, the motor retaining torque or the opening behavior of the coupling device in the area of the input converter device 8 can be purposefully adjusted. A so-called fail-safe behavior can thus be implemented which, for example, in case of failure of the electric motor, is configured so that the coupling device 5 is opened as result of the tension of a spring mechanism 25. This means that due to the tension of the spring mechanism 25 and to the degree of efficiency provided in the area of the ball thread 37, the spindle 16 is offset in rotational motion so that the spindle nut 17 is translatorily removed in axial direction from a disc set 19. Thereby the disc set 19 of the coupling device 5 is opened and the previously adjusted all-wheel drive of the motor vehicle is deactivated.

The above mentioned drag torques result from the practical development of the coupling device 5 and of the input converter device 8 described below:

The coupling device 5 is designed with one pressure plate 18 which is non-rotatably connected with the input shaft 2 and thus rotates at the same rotational speed as the input shaft 2 in the operation of the transfer device 5. The spindle nut 17 of the input converter device 8, during a closing operation of the coupling device 5, is moved in direction of the pressure plate 18, that is, in axial direction of the input shaft 2, so that frictional forces between the pressure plate 18 and the spindle 16 increases as the adjusting path of the spindle nut 17 increases and the above described drag torque assist a rotational motion of the spindle 16.

Due to the fact that during closing operation of the coupling device 4, the spindle 16 has the same direction of rotation as the input shaft 2; the drag torques assist the closing operation of the coupling device 5. An input torque to be applied by the electric motor 7 is thus reduced during the closing operation of the coupling device 5 compared to the design known from the practice.

Furthermore, during operation of the coupling device 5, as the axial adjusting path increases, the pressure plate 18 is moved to the multi-disc set 19 of the regulatable coupling device 5 designed as multi-disc clutch. The multi-disc set 19 consists of inner discs 20 and outer discs 21, the inner discs 20 being non-rotatably and movably connected in axial direction of the input shaft 2 with one internal disc carrier 22. The outer discs 21 are non-rotatably and movably connected in axial direction of the input shaft 2 with one external disc carrier 23 which, in turn, is non-rotatably connected with a first sprocket gear 24 of the CVT unit 6. The inner discs 20 and the outer discs are increasingly pressed with each other in a known manner during closing operation of the coupling device 5.

The internal disc carrier 22 is non-rotatably connected and axially not movable with the input shaft 2. The pressure plate 18 is spring mounted, via the spring mechanism 25, designed as a plate spring on the internal disc carrier 22 against the closing direction of the coupling device 5. Thus during an opening phase of the coupling device 5 in which the spindle nut 17 is removed from the coupling device 5, the pressure plate 18 is adjusted by the spring mechanism 25 in direction of the input converter device 8 whereby the transmission capacity of the coupling device 5 is reduced or entirely removed, depending on the opening degree of the coupling device 5.

According to the transmission capacity of the coupling device 5, adjusted via the above described control of the electric motor 7, part of the input torque introduced in the transfer transmission 1 via the input shaft 2 and varying with the transmission capacity momentarily existing is transmitted via the CVT unit 6 to the second output shaft 4.

FIG. 2 shows the instant electric motor 7, designed as a rotary field motor, is located in an inner space 27 of the transfer transmission 1 or of a housing 28 of the transfer transmission 1 in an area of the transfer transmission 1, defined by a pull strand 26A and a return strand 26B of the CVT unit 6. The placing of the electric motor 7 in the area of the inner space 27 of the transfer transmission 1, defined by the pull strand 26A and the return strand 26B, represents a most compact and space-saving design of the transfer transmission 1 whereby, compared to electric motors located outside the housing 28 of the transfer transmission 1, an easy assembly of the transfer transmission 1 is achieved and the inventive transfer transmission 1 needs little installation space in an area of a drive train of a motor vehicle.

Besides, the development of the electric motor 7 as a rotary field motor offers the possibility of making the electric motor of smaller dimensions compared to a version as a direct current motor. Compared to direct current motors with the same dimensions, rotary field motors generally have a higher power delivery. Especially in combination with the above described version of the input converter device 8, namely, that during a closing operation of the coupling device 5 the spindle 16 has the same direction of rotation as the input shaft 2, the advantageous result is that the electric motor 7 of the rotary field motor can have substantially smaller dimensions than a direct current motor of a transfer transmission known from the practice.

The design of the electric motor 7 as rotary field motor offers the further advantage of the electric motor 7 having a substantially longer service life, since it is operated almost wear-free and is characterized by great insensitivity to temperature. The rotary field motor 7 also has greater adjustment precision and less inertia moment than a direct current motor whereby an adjustment dynamic of the transfer transmission 1 is improved compared to conventional transfer transmissions.

There is the added possibility of constructing the electric motor 7, designed as a rotary field motor, without its own housing and cooling it with transmission oil since a cursor or a rotor 29 of the electric motor 7 can also be operated in transmission oil or other media, preferably coolants. This possibility does not exist, for example, in direct current motors designed with brushes, since these motors have to be encased, fully sealed, relative to the inner space 27 of the transfer transmission 1 and an admission of transmission oil.

In addition, by using a rotary field motor, it is advantageously possible to omit an electromagnetic brake by way of which a control torque is produced for the coupling device 5 to make keeping the coupling device 5 possible in closed state for a long period of time. In a rotary field motor, unlike in a direct current motor designed with brushes, a so-called burning of the brushes does not occur when current is supplied without rotary motion. In direct current motor, such burning of the brushes is caused by the fact that a direct current motor is for a long period of time supplied with current due to the locking torque to be applied and the direct current motor effects no rotation or is moved only within a small section of dial.

However, in an advantageous design of the inventive transfer transmission (not shown in detail) and different from the instant embodiment according to FIG. 1, an electromagnetic brake for locking the coupling device in the closed state can obviously be integrated in the transfer transmission when longer closing phases of the coupling device are desired by a corresponding competence profile, which represent an overload even for a rotary field motor or the control thereof.

The electric motor furthermore can also be designed as brush motor or the like depending on the existing application in order to be able to meet requirements specific to the application at hand.

The instant electric motor 7 is axially fixed between two housing halves 28A and 28B of the housing 28 of the transfer transmission 1 and can be protected from torsion by a fastening device 30 which interacts with a stator 31 of the electric motor in the housing 28 against distorting. The fastening device 30 can be designed as a fitting key or in the form of a lug of the housing which appropriately interacts with a recess corresponding therewith of the stator 31 of the electric motor 7.

In addition, the stator 31 of the electric motor 7 is supported upon the side of the electric motor 7 facing the spur gear stage 10 via a so-called bearing plate 33, here designed as a separate part non-rotatably disposed in the housing 28 of the transfer transmission 1, and supported upon the side remote from the spur gear stage 10 directly in the housing 28 of the transfer transmission 1.

At the expert's option discretion, it is also possible to support or fix the stator 31 of the electric motor 7 directly in the housing 28 of the transfer transmission 1 or via two support plates in the housing 28. In addition, the rotor 29 of the electric motor 7 is supported in the housing 28 or in the bearing plate 33 via low-friction bearings 32A, 32B. Depending on the application considered, it is also at the expert's discretion to provide the low-friction bearings for the rotor 29 directly in the housing 28 or in the intercalated bearing plate.

Alternative to this, the rotor of the electric motor can also be rotatably supported via roller bearings, such as ball roller bearings, directly in the housing or in the bearing plate situated between the rotor and the housing of the transfer transmission.

Should it be required to encase the electric motor 7 relative to the inner space 27 of the transfer transmission 1 since the electric motor is designed, for example, as a direct current motor with brushes, the electric motor 7 is integrated in the housing 28 of the transfer transmission 1 in the manner shown in FIG. 3 as a complete unit consisting of one housing 34, the stator 31, the rotor 29 and the bearings 32A and 32B. The bearing plate 33 and the halves 28B of the housing 28 of the transfer transmission 1 form the electric motor housing 34 and thus protects the electric motor 7 relative to the inner space 27 of the transfer transmission 1.

It evidently is also possible here to design the electric motor housing 34 by special shapings of both halves 28A, 28B of the housing 28 in the area of the electric motor 1 or to develop the electric motor 7 with a separate housing in the last mentioned alternative, it is easily possible to mount the electric motor as a part in the housing of the transfer transmission 1.

In FIG. 4 is shown one other embodiment of an inventively designed transfer transmission 1 in which the output shaft 12 of the electric motor 7 on which projects against the stator 31 the side of the electric motor 7 facing the first output shaft 3 so that the transfer transmission 1, according to FIG. 4, is designed without the countershaft 11 of the transfer transmission 1 shown in FIG. 1. The transfer transmission 1 according to FIG. 3, is thus designed with fewer parts than the development of the transfer transmission 1 according to FIG. 1.

The development of the transfer transmission 1, according to FIG. 1, where the outlet of the electric motor 7 is provided upon one side of the electric motor 7 facing a vehicle transmission (not shown in detail) by way of which the different reduction steps are adjusted or made available over the whole operation area of a motor vehicle, offers the possibility of saving axial installation space and implementing a favorable plug-in connection for current supply and control of the electric motor 7 on the side of the electric motor remote from the vehicle transmission.

FIG. 5 shows one other possible arrangement of the electric motor 7 in the inner space 27 of the transfer transmission 1 in which the electric motor 7 is situated outside the area of the inner space 27 of the transfer transmission 1 defined by the pull strand 26A and the return strand 26B of the CVT unit 6. This arrangement can then be prioritized, for example, in relation to the arrangement of the electric motor 7 shown in FIG. 2, when the dimensions of the electric motor 7 does not make an arrangement within a chain 36 of the CVT unit 6 possible.

The CVT unit 6 is designed with two sprocket gears 24 and 35 by way of which the chain 36 is guided. The sprocket gear 35 is connected with the second output shaft 4 so that when the coupling device 5 is closed in the traction operation of the drive train of the motor vehicle, part of the input torque of a prime mover of a motor vehicle fed via the input shaft 2, via the first sprocket gear 24 the chain 36 is guided to the second sprocket gear 35 and thus to the second output shaft 4. In the coasting operation of the motor vehicle one push torque, originating from drive wheels of the motor vehicle connected with the second output shaft 4, one push torque is guided via the CVT unit 6 and the coupling device 5 to the input shaft 2.

Furthermore, the CVT unit can also have belt means by using both coasting and traction forces and can be transmitted between the input shaft and the second input shaft of the transfer transmission.

### Reference Numerals

1 transfer transmission
2 input shaft
3 first output shaft
4 second output shaft
5 coupling device
6 CVT unit
7 electric motor
8 input converter device
9 first spur gear stage
10 second spur gear stage
11 countershaft
12 motor output shaft 30 fastening device
13A, 13B spur gear
14 toothed gear segment
15 spur gear or motor output shaft
16 spindle
17 spindle nut
18 pressure plate
19 multi-disc set
20 inner discs
21 out discs
22 internal disc carrier
23 external disc carrier
24 first sprocket gear
25 spring mechanism
26A pull strand (on load side)
26B return strand (on idle side)
27 inner space
28 housing
28A, 28B housing halves
29 rotor, cursor
31 stator
32A, 32B low-friction bearing
33 bearing plate
34 electric motor housing
35 second sprocket
36 chain
37 ball thread

1-17. (canceled)

18. A transfer transmission (1) with a regulatable coupling device (5) for a motor vehicle, in particular a motor vehicle with an engageable all-wheel drive, for distributing an input torque originating from a housing (28) via one input shaft (2) to at least two output shafts (3, 4) wherein a first output shaft (4) can be connected via the coupling device (5) with the input shaft (2) and the coupling device (5) is actuatable via one electric motor (7) and one input converter device (8) situated between the electric motor (7) and the coupling device (5) for converting a rotatory motion of the electric motor (7) to a translatory actuating motion of the coupling device (5) and wherein an axle offset between the input shaft (2) and one of the two output shafts (4) is bridged via a CVT unit (6), the electric motor (7) is integrated in the housing (28).

19. The transfer transmission according to claim 18, wherein the electric motor (7) is located in the housing (28) in an area defined by a pull strand (26A) and a return strand (26B) of the CVT unit (6).

20. The transfer transmission according to claim 18, wherein the electric motor (7) is located in the housing (28) outside an area defined by a pull strand (26A) and a return strand (26B) of the CVT unit (6).

21. The transfer transmission according to claim 18, wherein the electric motor (7) is designed as rotary field motor.

22. The transfer transmission according to claim 18, wherein the electric motor (7) is encased relative to an inner space (27) of the housing (28).

23. The transfer transmission according to claim 18, wherein the electric motor (7) is fixed in the housing (28) in an axial direction between two halves (28A, 28B) of the housing (28) and in exploded design is constructed without its own housing.

24. The transfer transmission according to claim 18, wherein one stator (31) of the electric motor (7) is supported at least upon one side in the housing (28) or in one part (33) fixed to the housing.

25. The transfer transmission according to claim 18, wherein one rotor (29) of the electric motor (7) is supported in one or more of a low-friction bearing (32A, 32B) in the housing (28) or one part (33) fixed to the housing.

26. The transfer transmission according to claim 18, wherein one rotor of the electric motor (7) is supported via one or more of a roller bearing device in the housing or one part fixed to the housing.

27. The transfer transmission according to claim 18, wherein one toothed wheel (15) of one of the two output shafts (12) of the electric motor (7) is situated upon a side of the electric motor (7) facing a main transmission of the drive train of the motor vehicle.

28. The transfer transmission according to claim 27, wherein the one of the two output shafts (12) of the electric motor (7) is operatively connected with the input converter device (8) via a toothed wheel (15), one countershaft (11) and at least one transmission unit (9, 10).

29. The transfer transmission according to claim 18, wherein the input converter device (8) is designed so that the coupling device (5) is open when the electric motor (7) is deactivated.

30. The transfer transmission according to claim 28, wherein the input converter device (8) has one spindle (16) and one spindle nut (17) situated thereon.

31. The transfer transmission according to claim 30, wherein the spindle is rotatorily fixed and the spindle nut is rotatable by the electric motor, the spindle nut having, during a closing operation of the coupling device, the same direction of rotation as the input shaft.

32. The transfer transmission according to claim 30, wherein the spindle nut (17) is rotatorily fixed and the spindle (16) is rotatable by the electric motor (7), the spindle (16) having during a closing operation of the coupling device (5) the same direction of rotation as the input shaft (2).

33. The transfer transmission according to claim 30, wherein the spindle (16) is designed as a ball threaded spindle with at least one thread.

34. The transfer transmission according to claim 33, wherein the pitch of the spindle thread is more than 1 mm.
